(19) United States
(12) Patent Application Publication
(10) Pub. No.: US 2006/0192926 A1
(43) Pub. Date: Aug. 31, 2006

(54) Video projector and optical engine

(76) Inventors: Kevin James Soper, Hope Valley (AU); Philip Brendan Banks, Modbury Heights (AU)

Correspondence Address: O M (Sam) Zaghmout, 8509 Kernon Ct, Lorton, VA, 22079, US

(21) Appl. No.: 10/550,449

(22) PCT Filed: Mar. 25, 2004
(86) PCT No.: PCT/AU04/00368

§ 371 Date: Nov. 17, 2005

(30) Foreign Application Priority Data
Mar. 25, 2003 (AU) 2003901353

(51) Int. Cl. G03B 21/22; G03B 21/14

(52) U.S. Cl. 353/119

(57) ABSTRACT

The present invention relates to a video projector (10) including a housing (18) and an optical engine (40) located therein for projecting an image onto a distal surface. The optical engine (40) includes a liquid crystal display (LCD) projector and further includes an objective lens (38) to focus the image. Such a configuration makes the projector (10) ruggedised in that the optical engine (40) securely holds all of the components necessary to project an image, including the objective lens (38). Furthermore, there exists a channel (42) between the optical engine (40) and the housing (18) which, together with a fan (58) and two strategically positioned cooling vents, allows for the optical components located within the optical engine (40) to be sufficiently cooled. The projector (10) operates through the use of a cooled transformer located in a base (12) which converts mains input, typically 240/110 V, to 12 V.

### BACKGROUND OF THE INVENTION

The present invention relates to a video projector and to an optical engine used in a video projector that is adapted for easy installation and that is designed to be ruggedised allowing it to be handled and moved without compromising the image quality.

The optical engine as per the present invention can be adapted for use in various projection systems and is particularly suitable to be useful as a docking engine, that is, the engine can be moved between dumb projection systems in discrete locations.

Image projection apparatus have been known for a number of years and fall into two distinct categories, the rear, and forward projection types. For example, a conventional television receiver is a rear projection apparatus, whilst a conventional cinema projector is a forward projection apparatus.

The currently known projectors have a number of difficulties and limitations.

The first of these is that all projection apparatus require sophisticated and complex optical engines and electronic components that are in-built into the apparatus. Frequently the apparatuses contain the use of LCD, DLP or cathode ray tube technologies that require precision optics to work. The complex optical engines increase the cost of these projectors meaning that quite often they are beyond the reach of the home consumer. Furthermore they are quite fragile and can be easily damaged or misaligned. Some are also typically heavy or cumbersome and are not intended to be truly portable apparatuses.

Because of this, projection apparatus are carefully stored and moved, and may in some instances be regarded as unsuitable for the displaying of large images in environments that are potentially hazardous to the equipment.

As such, they are typically used by skilled organisations in environments that seek to minimise exposure to the above risks. Accordingly they are not typically used in the home environment, even though this is where there is a clear need for a truly portable ruggedised projection system that can provide useful images to be seen by a number of people.

Even though some projectors have been marketed at a price that is within the reach of the home market they are still fragile and susceptible to failure of the alignment of the optical engines therein.

A further difficulty with projectors of the type that use LCD technology is the degradation of LCD panels and other similar display devices through exposure to ultra-violet rays, high heat or cigarette smoke, requiring constant maintenance and replacement of optical componentry.

Yet another problem with known projectors is the high replacement cost of their light sources where the globes are not only relatively expensive but in some instances difficult to replace.

A yet further problem of video projectors as currently known is that the globes required to produce an image also produce a significant amount of heat that needs to be dissipated and requires strong fans to produce an air flow around the globe. These globes also operate at mains Voltage, 240 Volts in Australia. Replacing the globes therefore requires that the power to the projection systems needs to be cut or there is a risk of electrocution.

It is an object of the present invention to provide an optical engine that overcomes at least some of the abovementioned problems or provides the public with a useful alternative.

It is a further object of the present invention to provide for a video projector employing an optical engine that overcomes at least some of the abovementioned problems or provides the public with a useful alternative.

It is a yet further object of the present invention to provide for a self-contained optical engine design that is adaptable for use in different projections apparatuses to produce images of different sizes.

### SUMMARY OF THE INVENTION

Therefore in one form of the invention there is proposed a projector including:

a housing; and

an optical engine, said optical engine including a liquid crystal display (LCD) projector to project an image displayed in said LCD projector and further including an objective lens to focus said image onto a distal surface therefrom.

Such a configuration makes the projector according to the present invention ruggedised in that the optical engine securely holds all of the components necessary to project an image and even if the optical engine were to be displaced the quality of the image would not be affected.

Preferably the LCD projector of said optical engine includes a series of optical elements through which a light source is adapted to pass.

In preference said light source is a collimated light source.

In preference said series of optical elements includes, in order of placement between said light source and said objective lens, an absorption heat filter, a polariser, a condenser lens, and an LCD display which includes an outer polariser.

Preferably said optical engine includes a base, two sides and a top clip adapted to hold said optical elements in predetermined fixed relationship. These four mechanical components of the optical engine provide a cradle for effectively holding the relative optical elements in a constant spatial separation.

Preferably said housing includes a body section adapted to house said optical engine and a lid whereby removal of said lid allows access into said body section.

In preference said housing includes one or more cooling vents and at least one fan adapted to draw air from outside of the housing into within the housing and then expel said air out of the housing through said cooling vents.

In preference said housing includes two strategically positioned cooling vents, a first cooling vent positioned substantially above said optical engine and a second cooling vent positioned at the rear of said housing whereby air from outside of said housing is drawn through said first vent by said fan and expelled through said second cooling vent.

Advantageously said fan is positioned directly in front of said second cooling vent.

Preferably said optical engine is elevated above the bottom of said housing enabling said air flow to flow underneath said optical engine and over said optical elements to thereby cool said elements.

In preference said body section houses further electronic componentry that contributes to projecting said image and provides further features to the projector such as audio means.

In preference said projector includes various inputs for connecting relevant devices to said projector and various control components for controlling characteristics of said image.

Preferably said projector further includes a transformer adapted to convert mains input that is typically some 240/110 Volts to 12 Volts.

In a further form of the invention there is proposed an image projection apparatus including:

a housing;

a light source positioned within said housing;

a fan positioned within said housing;

an optical engine including a longitudinal base member adapted to house an objective lens at its front end, two side walls extending upwards adjacent its rear end, an upper clip forming an enclosure with said side walls and said base member, said enclosure adapted to hold spaced apart optical elements therein such that said optical elements and said objective lens are coaxially aligned, said optical engine positioned within said housing in front of said light source;

a substantially hollow channel extending between said optical engine and said housing; and

at least two cooling vents forming part of said housing, said first vent located substantially above said optical engine, and said second cooling vent located at the rear of said housing, said fan drawing air from said first vent, through said channel and optical elements, and out of said housing through said second vent.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a schematic rear perspective view of a video projector embodying the present invention;

FIG. 2 is the projector of FIG. 1 with the top panel removed illustrating the optical engine and other internal components;

FIG. 3 is a cross-sectional view of the projector of FIG. 1 along its longitudinal axis;

FIG. 4 is a top view of the internal configuration of the projector of FIG. 1;

FIG. 5 is a rear cross-sectional view of the projector of FIG. 1;

FIG. 6 is an underside perspective view of a typical top panel of the projector of FIG. 1;

FIG. 7 is a front perspective view of the optical engine used in the projector of FIG. 1;

FIG. 8 is an exploded view of the optical engine of FIG. 6;

FIG. 9 is a rear perspective view of the optical engine of FIG. 6;

FIG. 10 is a top view of the optical engine of FIG. 6;

FIG. 11 is a cross-sectional view of the optical engine of FIG. 6;

FIG. 12 is a side view of the optical engine of FIG. 6; and

FIG. 13 is a rear perspective view of the base portion of the optical engine.

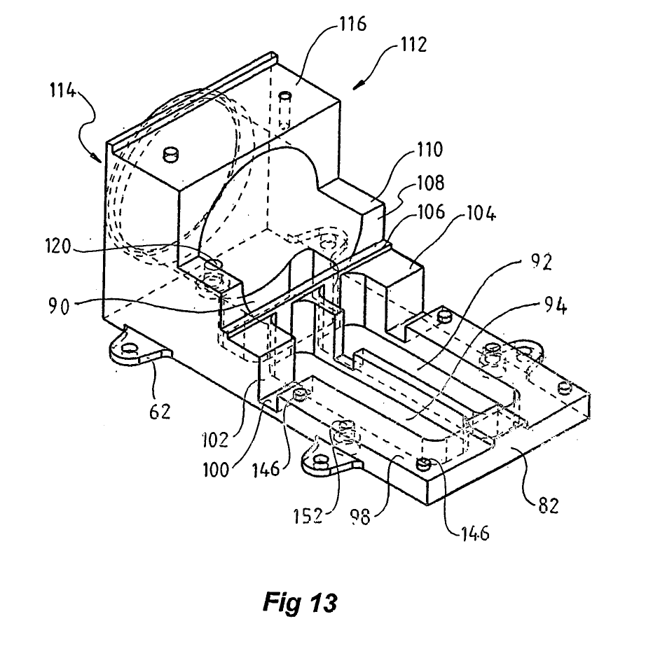

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

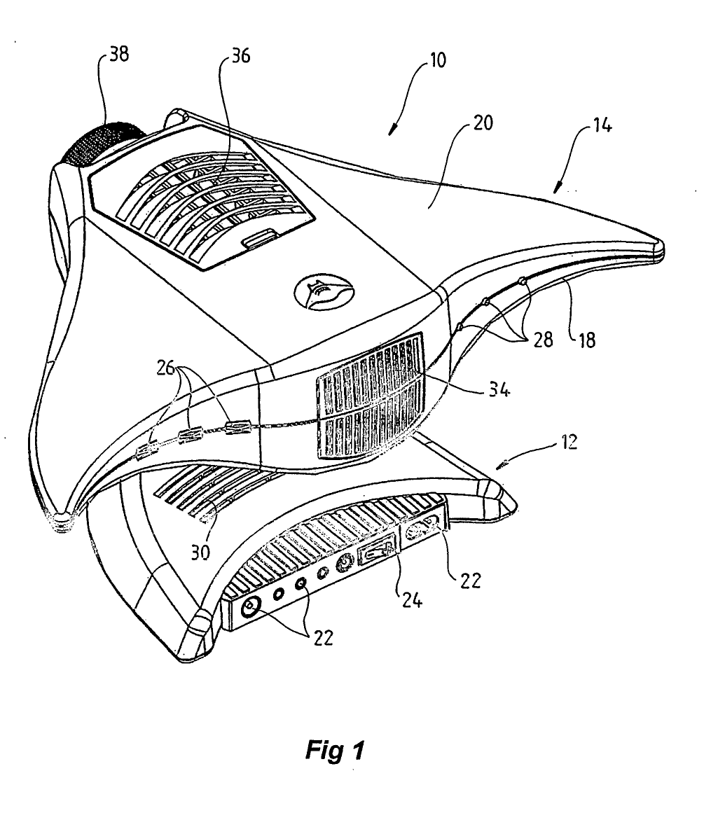

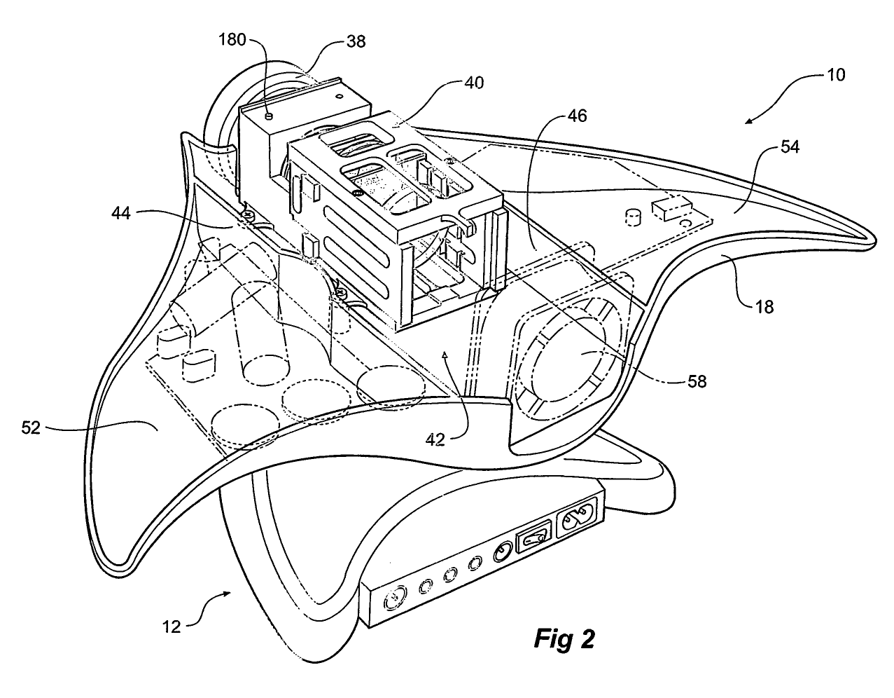

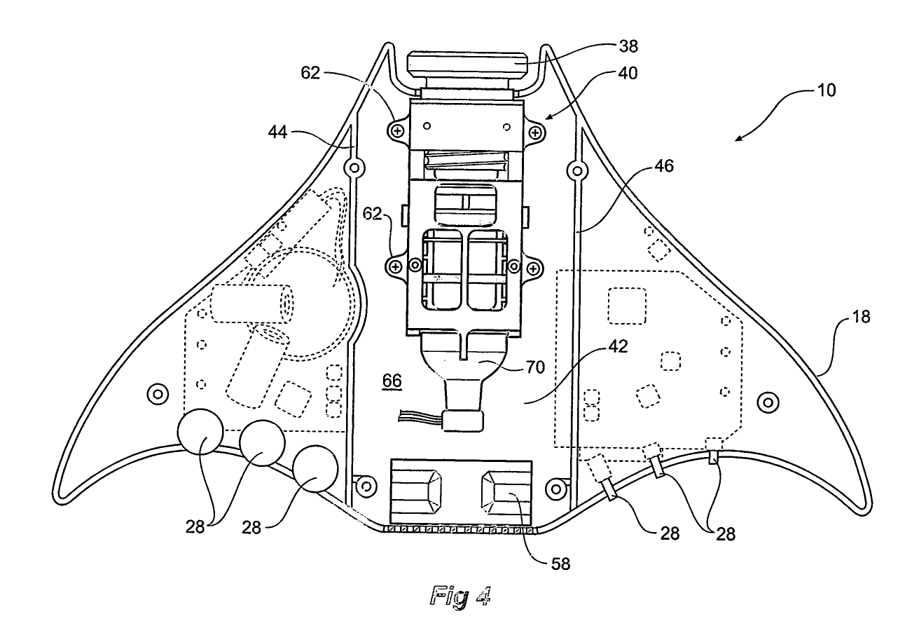

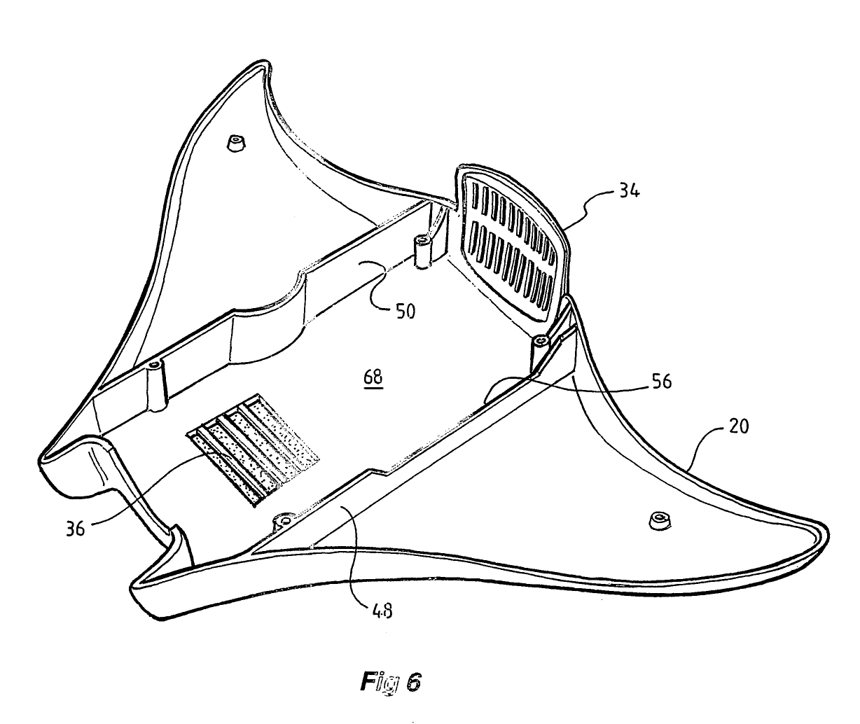

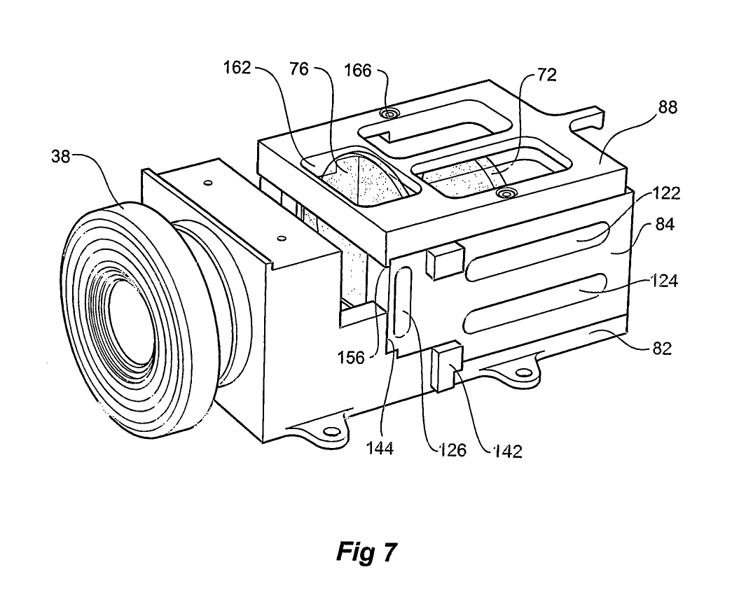

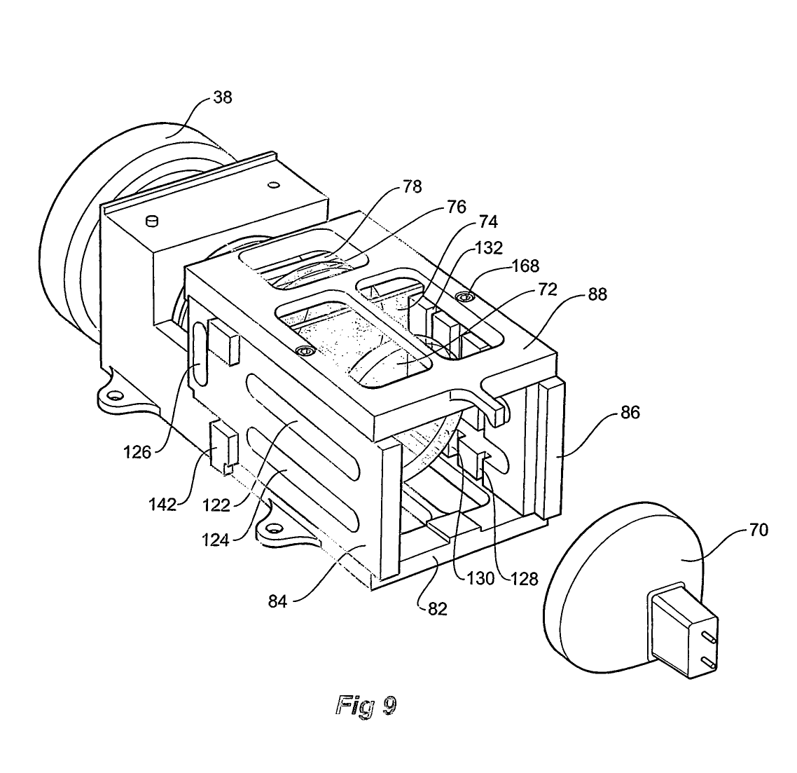

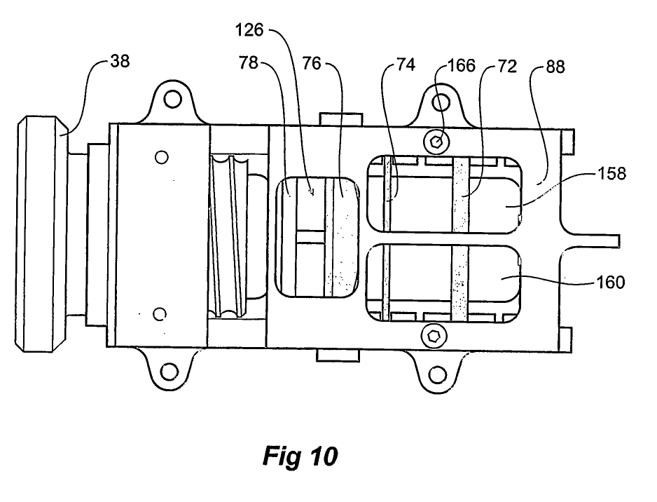

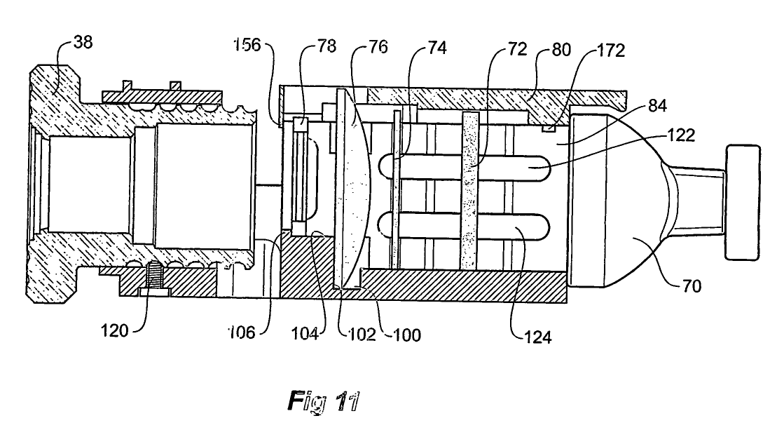

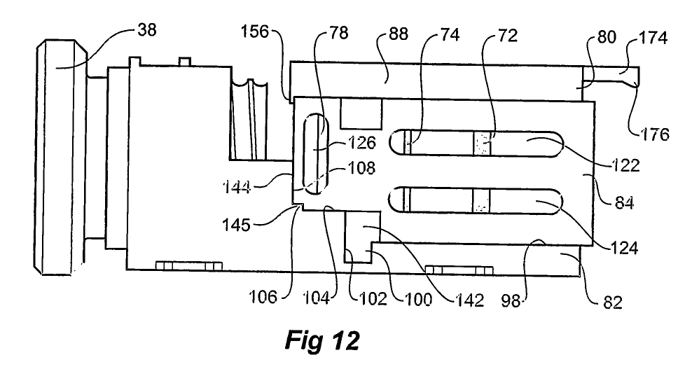

Illustrated in FIGS. 1 to 6 is a video projector embodying the present invention, whilst illustrated in FIG. 7 to 12 is the optical engine that is used to provide the image for the video projector. It is however to be understood that the optical engine could very well be used in other configurations of the video projector that is presented herein by virtue of example only. That is, the present invention is not limited to the shape and configuration of the video projector presented herein and that it may come in different shapes and sizes with only some features being common across a host of video projectors. Those features and their roles will be clearly discussed in the following description.

Dealing first with the video projector and looking in particular at FIGS. 1 to 3, the video projector 10 includes a base 12 supporting a body 14 through support arm 16. The body 14 includes a bottom housing 18 and a top lid 20 attached to each other using common means such a screws (not shown). Removal of the top lid 20 allows access into the body of the projector 10. Positioned at the rear of the base 12 are numerous inputs 22 and a switch 24 that provides power to the electronic componentry inside the projector. Located at the rear of the body 14 are also numerous controls 26 and 28 on either side of the projector that control common componentry including control of the picture brightness and contrast as well as sound.

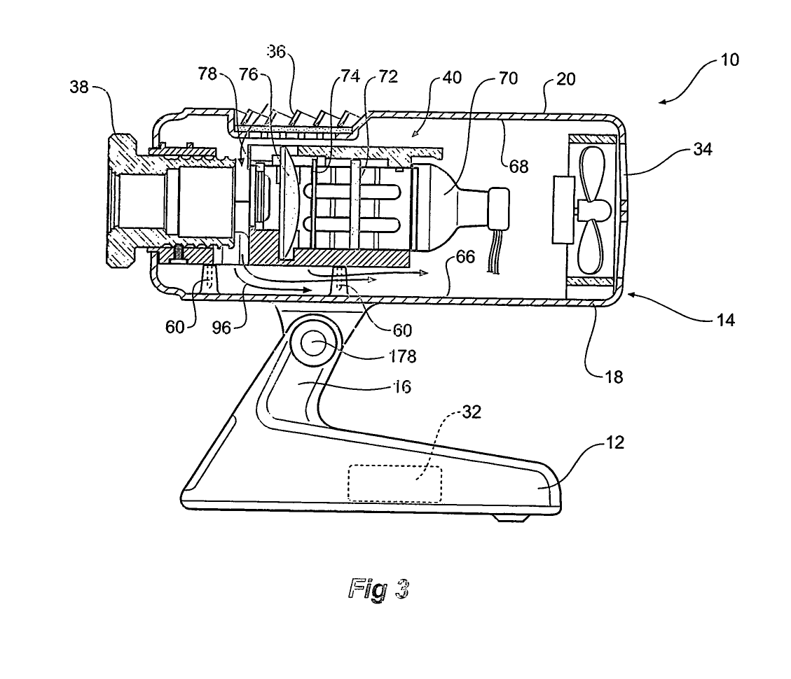

The top of the base includes cooling vents 30 that provide for the cooling of the transformer 32 located in the base that is shown in FIG. 3 and that converts the mains input that is typically some 240/110 Volts to 12 Volts. This is an important feature of the present invention, one whose contribution will be discussed in more detail further on. It suffices to say that use of a low Voltage throughout the projector 10 overcomes the problem of safety especially when one needs to change the light source.

At the rear of the body 14 is an outlet vent 34 for expelling air drawn in through inlet vents 36 located at the top of and towards the front of the lid 20. An objective lens 38 extends outwardly from the projector 10.

Located centrally within the body 14 is an optical engine 40 whose configuration will be discussed in much more detail later. In brief, the optical engine 40 includes all of the components necessary to produce and project an image. The engine 40 is located within a channel 42 that is defined by internal walls 44 and 46 on either side of the optical engine 40 that extend upwardly from the base 18 and by walls 48 and 50 extending downwardly from the lid 20. The remaining spaces 52 and 54 on either side of the channel 42 are filled with various electronic componentry and boards (illustrated as dashed lines) that are used to provide the image to be projected as well as other features, such as audio. The walls 44, 46, 48, and 50 are typically straight, but they may include other shapes to accommodate componentry within the spaces 52 and 54. Further they may include openings or apertures to enable electrical communication between the equipment housed in spaces 52 and 54 and with the optical engine 40. Thus, for example, the wall 48 of the lid 20 may not adjoin wall 44 but be recessed to leave a gap 56 for the passage of electrical connections therethrough. Overall though, with the exception of a few apertures or holes, the channel is fairly well isolated from the rest of the projector 10. This enables an electrical fan 58 positioned at the rear of the projector and in front of outlet vents 34 to draw air through the channel 42 and hence the optical engine 40, the air entering the channel 42 through inlet vents 36 on the lid 20. The position of the inlet vents 36 is deliberately chosen so that maximum air flows over those components in the optical engine that need to be kept cool. Again, the particulars of the optical engine will be discussed later.

The optical engine is attached to the base 18 by using screws 60 passing through optical engine feet 62 co-axially aligned with threaded shafts 64 on the bottom 18. The shafts keep the optical engine raised above the floor 66 of the bottom housing 18 so that air can flow freely underneath the optical engine 40 when mounted in the projector 10. One can now also appreciate that the optical engine can be easily replaced by simply unscrewing it from the base. Of course, there may equally well be other types of securing means to attach the optical housing to the base such as a snap fit arrangement provided that there remain sufficient air gaps to enable air flow. One of the reasons as to why that is not critical is that the optical engine includes all of the components necessary to produce an image including the objective lens 38 and no precise alignment is required between other components that in other projectors are housed in separate locations to the base. This is one of the important advantages of the present invention over all of the other projectors known to the applicant.

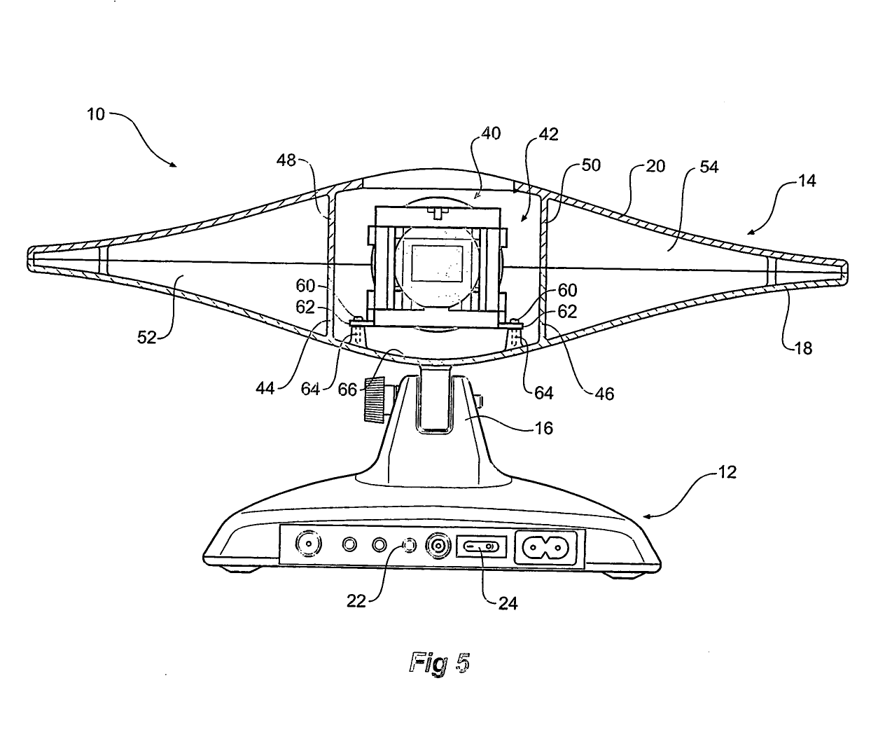

Of course, the cross-sectional size of the optical engine is also smaller than the channel 42 so that air can also flow freely around the whole of the optical engine, that is, in the longitudinal gaps between the walls 44, 46, 48, and 50 as well as between the inner surface 68 of the top lid 20. This is best illustrated in FIGS. 3 and 5 that show different cross-sections of the projector 10 illustrating the gaps around all sides of the optical engine and the body 14. The air that is then drawn by the fan through the optical engine and the gaps provides the necessary cooling for the optical engine components. For the particular optical engine that will be now discussed, it was found that airflow of some 30 cubic feet per minute was sufficient to provide all of the necessary cooling.

FIGS. 7 to 12 illustrate an optical engine embodying the present invention and that is used in the projector described earlier. It is to be understood that the optical engine has been designed to be able to be enlarged or reduced so as to fit into different size projectors whilst maintaining a good image projecting capability and that the following description referring to particular geometric sizes is not intended to be limiting.

The optical engine 40 includes all of the optical components necessary to construct and project an image from the projector. The order of the components is as follows. First a collimated light source 70 emits light that passes through an absorption heat filter 72, through a polariser 74, condensor lens 76, a liquid crystal display (LCD) 78 that includes an outer polariser 80, and an objective lens 38 discussed earlier that then focuses the image onto a distal surface. These components will be discussed in more detail later.

All of the components are supported within the optical engine 40 that includes a base 82, sides 84 and 86, the sides being a mirror image, and a top securing clip 88. The base includes three apertures or gaps 90, 92 and 94, the apertures positioned underneath the optical components 78 to enable air flow 96 to pass around them and through the base where it then flows to the air fan underneath the channel (shown in FIG. 3) to be expelled through the outlet vents 34.

Starting at the rear of the base 82 and working towards the objective lens the base includes a flat rear first surface 98 consisting of three longitudinal sections defining apertures 92 and 94 on top of which are supported the heat filter 72 and polariser 74. A groove 100 extending across the base is used to support the condenser lens 76 that also rests against first shoulder 102, the first shoulder stepping up to a flat second surface 104 used to support the LCD 78, the LCD also abutting against lip 106. The lip 106 ensures that no stray light bypasses the LCD 78. Extending generally upwardly from the lip 106 is a second shoulder 108 that is used to locate sides 84 and 86 as will be discussed later. The second shoulder 108 terminates in a third flat surface 110, the base 82 then including a rectangular collar 112 defining an aperture 114 engaged by the objective lens 38. The collar 112 includes a flat fourth surface 116 that can be used to support a small electronic board to feed data into the LCD 78 (not shown). The objective lens includes outer threads 118 that engage screw 120 so that as the objective lens 38 is rotated it is caused to move in and out of the optical engine 40 (respectively by rotating clockwise or anti-clockwise) thus focussing any image passing through the optical engine.

Sides 84 and 86 are configured to be mirror images of each other and for the sake of brevity only one side will be discussed, the reader being advised that the configuration of the other side identical except being a mirror image.

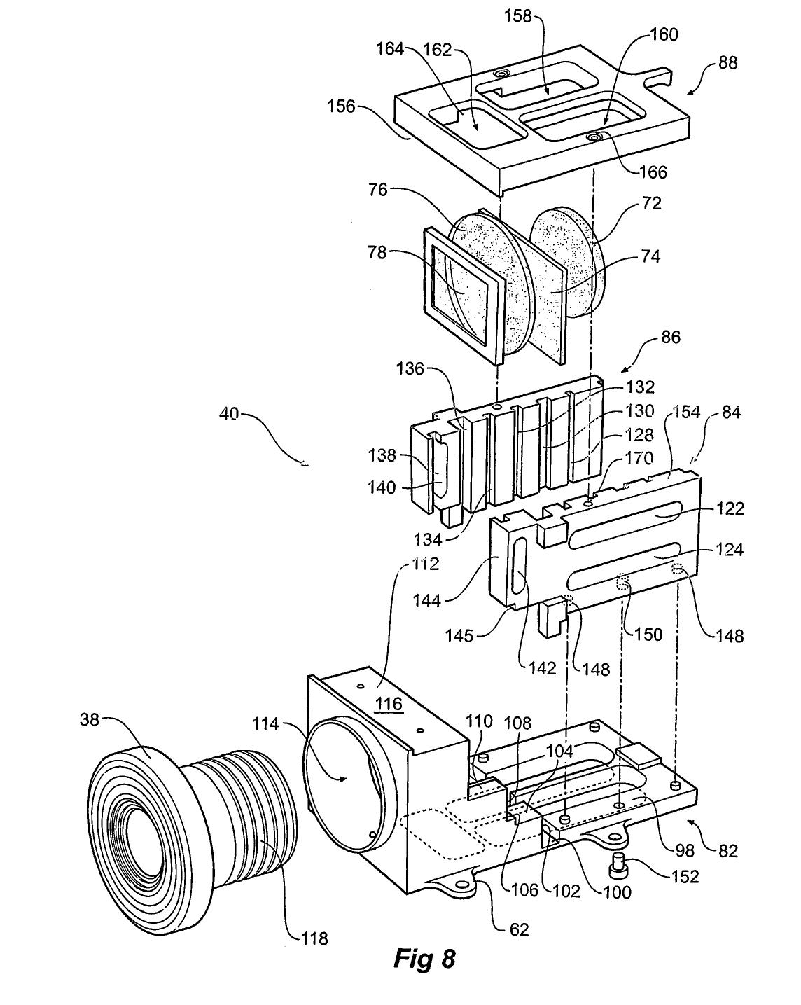

Thus side 84 includes two longitudinal apertures or slits 122 and 124 that allow air flow around the optical components held by the engine 40. A single generally vertical aperture 126 adjacent the LCD 78 also assists in air flow around the LCD. The inner surface of the side 84 includes vertical grooves or slits that support the various optical components. However, there are typically more grooves than optical components. The extra grooves are provided for the case if one needs to use additional heat filters. Thus, referring specifically to FIG. 8, the first groove 128 is not used, the second 130 groove is used to support the heat filter 72, the third groove 132 is not used, the fourth groove 134 is used to support the polariser 74, the fifth groove 136 is used to support the condenser lens 76 and the sixth and last groove 138 is used to support the LCD 78. The sixth groove 138 also includes a recess 140 to allow for airflow around the LCD.

Side 84 engages the base groove 100 using a correspondingly shaped bottom projection 142. The reader should now appreciate that the side projection 142 and the side front shoulder 144 help to position the side 84 on the base 82, the shoulder abutting the base second shoulder 108 and including a cutout 145 to accommodate lip 106. To further assist in locating the side 84 on the base 82 the optical engine uses dowels including dowel pins 146 on the base engaging holes 148 in the side, the side also having a threaded bore 150 to be engaged by a screw 152 passing through the base.

The upper surface 154 of the side 84 is of a flat configuration and is used to support the top clip 88, the clip including a downward lip 156 that engages side front surface 144. The lip extends below across between the two sides 84 and 86 and provides a block against any stray light exiting the optical engine, much like the lip 106 below. The clip 88 includes apertures 158, 160 and 162, aperture 162 parallel to, and adjacent LCD 78 to allow for airflow therethrough. The underside of the clip 88 may include a recess 164 to accommodate the various optical components of a larger diameter such as the polariser 74 and the condenser lens 76. Apertures 166 in the clip 88 enable a screw 168 to engage threaded bores 170 in the sides 84 and 86. As with the sides 84, 86 and the base 82, the clip 88 and the sides 84 and 86 may very well use dowels 172 for locating and holding the parts for relative movement.

The reader will now appreciate that the four mechanical components, namely the base, sides and clip provide a cradle for effectively holding the optical components in a spatial arrangement thus providing a ruggedised capability in that the optical engine performance is not affected by the position of the engine within the projector. This is especially so since unlike existing projectors, the objective lens is fixed to the optical engine whereas in existing projectors it is fixed to the projector itself.

The reader will also appreciate that the mechanical components, that are typically made of lightweight material such as aluminium, offer good heat dissipating properties and include various apertures that enable air to flow all around the optical engine components to ensure that they are kept cool and within operating tolerances. This is important in relation to the LCD that is susceptible to heat damage. With apertures adjacent and parallel to the LCD one ensures that air flows all around the LCD.

Clip 88 further includes a rear projection 174 that includes dimple 176. This assists in locating and fixing the lamp to the optical engine. Although not shown it is to be understood that a door is located on the bottom housing 18 adjacent the lamp enabling the lamp to be easily replaced. The door further includes a biased aluminium plate that ensures that the lamp is held tightly within the projector but not too tightly so that the lamp can move under impact. The contact between the plate and the lamp also ensures that the plate thus helps to cool the lamp by dissipating heat. A sensor may also be strategically positioned on the plate to act as a thermal overload in case the optical engine gets too hot (typically more than 60 degrees Centigrade). The reader will now appreciate that as the projector operates at only 12 Volts, it enables the ordinary user to replace and change the lamp. Further, given that the lamp is only some 12 Volts means that it is relatively inexpensive when compared to normal projector lamps that may cost hundred of dollars and require special handling to replace. The lamp includes a longitudinal filament and a collimating reflector to reduce the focal point of the filament on the projected image. Faceted reflectors optimise the light fed to the LCD.

The projector is shaped to be visually pleasing, in this particular case resembling the marine animal known as the Manta Ray. Of course it is not intended to limit it to that particular shape and may other shapes may equally well be used. The base and the bottom housing are joined by arm 16 that may also be pivotable by the use of locking screw 178

It should now be apparent to the reader that the present invention provides for a 12 Volt LCD projector that is inexpensive to manufacture. This is achieved in part by the unique design of the optical engine mechanical componentry that allows air to flow around the various components thus ensuring that they are kept cool, especially the LCD panel. This minimises the number of heat absorption components that need to be in the optical pathway of the light maintaining a high degree of illumination given that every time light passes through an optical surface a small percentage is lost.

All elements of the optical engine, including the lamp, are typically selected to filter out ultra violet light, which adversely affects the epoxy resin plug, which is used within the LCD to hold the liquid crystal. Additionally elements have been designed to dissipate the heat to protect the LCD that is degraded through excessive heat.

Referring now to the optical engine as per the present embodiment the following are the configurations and dimensions of the various components:
(a) The Heat filter is a dichroic infrared heat filter perpendicular to the longitudinal axis although in some instances it may not be at a right angle to reflect infra red light out of the optical engine.
(b) The polariser is mounted and/or sprayed/placed on the glass at linear polarization to the filter on the LCD. The polariser filter can be swapped to an alternative filter mounted on the LCD. This filter is rectangular for ease of production.
(c) The condenser lens is designed and curved towards the light source to evenly distribute illumination across the LCD panel. It may be coated with an antireflective coating too and may be made from suitable plastic. It is some 39.5 mm in diameter with a radius of R27.0+/−1.0 and a width of 10 mm.
(d) The LCD, which is an amorphous panel, is mounted with a polarizer on the far side of the panel. In some embodiments one may have polarizer on the LCD in which case the fixed one is not required.
(e) The objective lens, using the well-known Cook design, is designed to suit the light train and to maximize light efficiency by the use of anti reflective coatings on both sides of each lens.
(f) The location of the various components is as follows referring to the relative positions on the sides 84 and 86. Thus the sixth groove 138 is between 2.45-6.05 mm from the front edge of the side 84, the fifth groove 136 some 13.25-19.65 mm, the fourth groove 134 some 26.37-29.12 mm, the third groove 132 some 35.55-37.45, the second groove 130 some 43.83-47.73 mm and the first groove 128 some 54.10-56 mm.

Other improvements may very well be made to the invention including locating lugs 180 on the optical engine to assist in locating circuit boards and the like (not shown). The lenses have chamfered edges on one edge for ease of identification and ensure correct orientation of the lenses in production. Spacers in the objective lens are also chamfered to ensure correct location when assembling. The vents may include filters to collect dust. The reader will now appreciate that the optical engine and video projector according to the present invention provides a number of advantages over known projectors including the following:
Ruggedised equipment for gaming and youth markets.
   Portability of equipment.
   Expansion of viewing environments to include those previously considered too hazardous for the more fragile projectors.
Enhanced viewing possibilities (i.e. use with forward or rear projection systems, for dimmed home theatre environment or rear projection in full ambient light); customized power supply requirements for 12 v or 24 v environments; and total upgradability in the event of the LCD or other display device being degraded, damaged or an upgrade being required).

Other features may very well be provided to enhance the capability of the present invention including television reception, navigation systems utilising GPS, different inputs allowing the projector to be fed 240 Volts, 110 Volts or even 24 Volts. The projector could also be used in a rear project screen.

Further advantages and improvements may very well be made to the present invention without deviating from its scope. Thus it is not intended to limit the invention to the precise dimensions and relative distances of the optical components that indeed may vary. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

1. A projector including:
a housing; and
an optical engine, said optical engine including a liquid crystal display (LCD) projector to project an image displayed in said LCD projector and further including an objective lens to focus said image onto a distal surface therefrom.

2. A projector as in claim 1 wherein the LCD projector of said optical engine includes a series of optical elements through which a light source is adapted to pass.

3. A projector as in claims 1 or 2 wherein said light source is a collimated light source.

4. A projector as in claim 3 wherein said series of optical elements includes, in order of placement between said light source and said objective lens, an absorption heat filter, a polariser, a condenser lens, and an LCD display which includes an outer polariser.

5. A projector as in claim 4 wherein said optical engine includes a base, two sides and a top clip adapted to hold said optical elements in predetermined fixed relationship.

6. A projector as in any one of the above claims wherein said housing includes a body section adapted to house said optical engine and a lid whereby removal of said lid allows access into said body section.

7. A projector as in any one of the above claims wherein said housing includes one or more cooling vents and at least one fan adapted to draw air from outside of the housing into within the housing and then expel said air out of the housing through said cooling vents.

8. A projector as in claim 7 wherein said housing includes two strategically positioned cooling vents, a first cooling vent positioned substantially above said optical engine and a second cooling vent positioned at the rear of said housing whereby air from outside of said housing is drawn through said first vent by said fan and expelled through said second cooling vent.

9. A projector as in claim 8 wherein said fan is positioned directly in front of said second cooling vent.

10. A projector as in any one of the above claims wherein said optical engine is elevated above the bottom of said housing enabling said air flow to flow underneath said optical engine and over said optical elements to thereby cool said elements.

11. A projector as in any one of the above claims wherein said body section houses further electronic componentry that contributes to projecting said image and provides further features to the projector such as audio means.

12. A projector as in any one of the above claims wherein said projector includes various inputs for connecting relevant devices to said projector and various control components for controlling characteristics of said image.

13. A projector as in any one of the above claims wherein said projector further includes a transformer adapted to convert mains input that is typically some 240/110 Volts to 12 Volts.

14. An image projection apparatus including:
a housing;
a light source positioned within said housing;
a fan positioned within said housing;
an optical engine including a longitudinal base member adapted to house an objective lens at its front end, two side walls extending upwards adjacent its rear end, an upper clip forming an enclosure with said side walls and said base member, said enclosure adapted to hold spaced apart optical elements therein such that said optical elements and said objective lens are coaxially aligned, said optical engine positioned within said housing in front of said light source;
a substantially hollow channel extending between said optical engine and said housing; and
at least two cooling vents forming part of said housing, said first vent located substantially above said optical engine, and said second cooling vent located at the rear of said housing, said fan drawing air from said first vent, through said channel and optical elements, and out of said housing through said second vent.
